(19) United States
(12) Patent Application Publication
(10) Pub. No.: US 2025/0117895 A1
(43) Pub. Date: Apr. 10, 2025

(54) IMAGE PROCESSING APPARATUS, INSPECTION APPARATUS, IMAGE PROCESSING METHOD, AND INSPECTION METHOD

(71) Applicant: Lasertec Corporation, Yokohama (JP)

(72) Inventors: Hiroki MIYAI, Yokohama (JP); Takayuki MORISAWA, Yokohama (JP)

(73) Assignee: Lasertec Corporation, Yokohama (JP)

(21) Appl. No.: 18/904,333

(22) Filed: Oct. 2, 2024

(30) Foreign Application Priority Data
Oct. 5, 2023 (JP) 2023-173685

(51) Int. Cl. G06T 5/70

(52) U.S. Cl. CPC G06T 5/70

(57) ABSTRACT

An image processing apparatus according to this embodiment includes: a specifying unit configured to specify, when parameter values of illumination parameters at a plurality of points corresponding to pixels of a photographed image obtained by photographing an object at a predetermined sampling time are compared with each other, a plurality of peak points each of which is a peak with respect to surrounding parameter values; a generation unit configured to generate, based on respective peak values of the parameter values at the specified plurality of peak points, the parameter values at a plurality of points between the peak points, and thereby generate a distribution of the parameter values; and a correction unit configured to correct the photographed image obtained at the predetermined sampling time by correcting the parameter values of at least one pixel of the photographed image.

### INCORPORATION BY REFERENCE

This application is based upon and claims the benefit of priority from Japanese patent application No. 2023-173685, filed on Oct. 5, 2023, the disclosure of which is incorporated herein in its entirety by reference.

### BACKGROUND

The present disclosure relates to an image processing apparatus, an inspection apparatus, an image processing method, and an inspection method.

Patent Literature 1 discloses that a reference image is acquired in advance, and a photographed image is corrected based on a distribution of luminance on the reference image by illumination light.
Patent Literature 1: Japanese Patent No. 6591348

### SUMMARY

When a sample such as a photomask is inspected by using illumination light, the distribution of luminance of the illumination light may change over time, so it has been desired to improve countermeasures to be taken against such changes in the distribution of luminance caused by a temporal factor. However, in the related-art method in which the distribution of luminance is corrected by using the distribution of luminance on the reference image acquired in advance, it is conceivable that the distribution of luminance of the illumination at the time when the reference image was acquired and the distribution of luminance of the illumination at the time when an inspection image is acquired differ due to the temporal factor, and thus in some cases, sufficient countermeasures cannot be taken.

The present disclosure has been made in view of such a problem, and an object thereof is to provide an image processing apparatus, an inspection apparatus, an image processing method, and an inspection method capable of improving countermeasures to be taken against changes in a distribution of luminance caused by a time variation factor.

An image processing apparatus according to an aspect of the present disclosure includes: a specifying unit configured to specify, when parameter values of illumination parameters at a plurality of points corresponding to pixels of a photographed image obtained by photographing an object at a predetermined sampling time are compared with each other, a plurality of peak points each of which is a peak with respect to surrounding parameter values; a generation unit configured to generate, based on respective peak values of the parameter values at the specified plurality of peak points, the parameter values at a plurality of points between the peak points, and thereby generate a distribution of the parameter values; and a correction unit configured to correct the photographed image obtained at the predetermined sampling time by correcting the parameter values of at least one pixel of the photographed image based on the generated distribution of the parameter values.

In the above-described image processing apparatus, the generation unit may generate the parameter values at the plurality of points between the peak points by interpolating the parameter values based on the peak values.

In the above-described image processing apparatus, the correction unit may correct the parameter values by a smoothing process.

In the above-described image processing apparatus, the object may have a repetitive pattern in which a plurality of patterns formed with substantially the same pattern width are arranged, and the specifying unit may specify the peak points having the peak values larger than a threshold for the parameter values, the threshold being set based on the pattern width.

In the above-described image processing apparatus, the object may have a repetitive pattern in which a plurality of patterns formed with substantially the same pattern width are arranged, the image processing apparatus may further include a determining unit configured to determine whether a distribution of positions of the specified plurality of peak points corresponds to a distribution of the patterns, or whether distributions of the parameter values of respective patterns are similar to each other, and when the determination unit determines that distributions correspond to each other or are similar to each other, the correction unit may correct the photographed image.

The above-described image processing apparatus may further include a determination unit configured to compare a first distribution of the parameter values generated based on a photographed image of the object at a sampling time earlier than the predetermined sampling time with a second distribution of the parameter values generated based on a photographed image of the object at the predetermined sampling time, and thereby determine a degree of difference between the first and second distributions, in which when the determination unit may determine the first and second distributions are different from each other, the correction unit may correct the photographed image of the object obtained at the predetermined sampling time by correcting a parameter value of at least one pixel of the photographed image based on the second distribution.

The image processing apparatus may further include: an extraction unit configured to extract a variation characteristic of a time-dependent temporal variation and a variation characteristic of a position-dependent spatial variation in the distribution of parameter values based on the first and second distributions; and a prediction unit configured to predict a predicted distribution of the parameter values at a third sampling time later than the predetermined sampling time based on the extracted variation characteristics, the generation unit may generate a third distribution of the parameter values based on the photographed image of the object obtained at the third sampling time, the determination unit may compare the predicted distribution with the third distribution, and thereby determine a degree of similarity between the predicted distribution and the third distribution, and when the determination unit determines that the predicted distribution and the third distribution are similar to each other, the correction unit may correct the photographed image based on the third distribution.

In the above-described image processing apparatus, the determination unit may determine a degree of similarity between the predicted distribution and the third distribution by comparing a high-frequency component in the variation characteristic of the spatial variation of the predicted distribution with a high-frequency component in the variation characteristic of the spatial variation of the third distribution.

In the above-described image processing apparatus, the parameter value of illumination light that is applied to the object when the object is photographed may become smaller from a center of the photographed image toward to an end thereof, and an end of a beam of the illumination light that is applied to the object may be included in the photographed image.

In the above-described image processing apparatus, the object may be a photomask in which a pellicle is formed, and the illumination light may include EUV.

An image processing apparatus according to an aspect of the present application includes: a specifying unit configured to specify, when parameter values of illumination parameters at a plurality of points corresponding to pixels of a photographed image obtained by photographing an object at a predetermined sampling time by using a part of illumination light are compared with each other, a plurality of peak points each of which is a peak with respect to surrounding parameter values; a generation unit configured to generate, based on respective peak values of the parameter values at the specified plurality of peak points, the parameter values at a plurality of points between the peak points, and thereby generate a fourth distribution of the parameter values and generate a fifth distribution of the parameter values at a plurality of points corresponding to pixels of a monitor image photographed by receiving another part of the illumination light; a determination unit configured to determine a degree of similarity between the fourth and fifth distributions by comparing the fourth and fifth distributions; and a correction unit configured to correct the photographed image obtained at the predetermined sampling time by correcting the parameter values of at least one pixel of the photographed image based on the generated fourth distribution, in which when the determination unit determines that the fourth and fifth distributions are similar to each other, the correction unit corrects the photographed image.

In the above-described image processing apparatus, when the determination unit determines that the fourth and fifth distributions are not similar to each other, the determination unit may determine that there is an abnormality.

In the above-described image processing apparatus, the determination unit may extract a difference between the fourth and the fifth distributions, and the correction unit may correct the fifth distribution based on the difference.

The above-described image processing apparatus may further include a storage unit configured to store a state parameter of an apparatus in which the object is photographed at the sampling time at which a predetermined difference is extracted, together with the predetermined difference, in which when the determination unit determines that the same state parameter is acquired later than the sampling time, the correction unit may correct the fifth distribution based on the predetermined difference.

An inspection apparatus according to an aspect of the present disclosure includes: an illumination optical system configured to illuminate an object using illumination light; a photographing optical system configured to take a photographed image of the object illuminated by the illumination light; and the above-described image processing apparatus, in which the image processing apparatus inspects the object by using the photographed image that has been subjected to image processing.

An image processing method according to an aspect of the present disclosure includes: specifying, when parameter values of illumination parameters at a plurality of points corresponding to pixels of a photographed image obtained by photographing an object at a predetermined sampling time are compared with each other, a plurality of peak points each of which is a peak with respect to surrounding parameter values; generating, based on respective peak values of the parameter values at the specified plurality of peak points, the parameter values at a plurality of points between the peak points, and thereby generating a distribution of the parameter values; and correcting the photographed image obtained at the predetermined sampling time by correcting the parameter values of at least one pixel of the photographed image based on the generated distribution of the parameter values.

An inspection method according to an aspect of the present disclosure includes: illuminating an object using illumination light; taking a photographed image of the object illuminated by the illumination light; correcting the photographed image by the above-described image processing method; and inspecting the object by using the photographed image that has been subjected to image processing.

According to the present disclosure, it is possible to provide an image processing apparatus, an inspection apparatus, an image processing method, and an inspection method capable of improving countermeasures to be taken against changes in a distribution of luminance caused by a time variation factor.

The above and other objects, features and advantages of the present disclosure will become more fully understood from the detailed description given hereinbelow and the accompanying drawings.

### BRIEF DESCRIPTION OF DRAWINGS

FIG. 1 is a configuration diagram showing an example of an inspection apparatus according to a first embodiment;

FIG. 2 is a block diagram showing an example of an image processing apparatus according to the first embodiment;

FIG. 3 is a diagram showing an example of a photographed image acquired by the image processing apparatus according to the first embodiment, and parameter values along a line III-III;

FIG. 4 is a diagram showing an example of a photographed image in which a specifying unit specifies peak points, and parameter values along a line IV-IV in the image processing apparatus according to the first embodiment;

FIG. 5 is a diagram showing an example of a distribution of parameter values generated by a generation unit, and parameter values along a line V-V in the generated distribution in the image processing apparatus according to the first embodiment;

FIG. 6 is a diagram showing an example of a photographed image corrected by a correction unit, and parameter values along a line VI-VI in the image processing apparatus according to the first embodiment;

FIG. 7 is a flowchart showing an example of an image processing method using the image processing apparatus according to the first embodiment;

FIG. 8 is a flowchart showing an example of an inspection method using the inspection apparatus according to the first embodiment;

FIG. 9 is a block diagram showing an example of an image processing apparatus according to Modified Example 1 of the first embodiment;

FIG. 10 is a flowchart showing an example of an image processing method using the image processing apparatus according to Modified Example 1 of the first embodiment;

FIG. 11 is a flowchart showing an example of an image processing method using an image processing apparatus according to another example of Modified Example 1 of the first embodiment;

FIG. 12 is a block diagram showing an example of an image processing apparatus according to Modified Example 2 of the first embodiment;

FIG. 13 is a flowchart showing an example of an image processing method using the image processing apparatus according to Modified Example 2 of the first embodiment;

FIG. 14 is a block diagram showing an example of an inspection apparatus according to a second embodiment;

FIG. 15 is a block diagram showing an example of a monitor unit in the inspection apparatus according to the second embodiment;

FIG. 16 is a block diagram showing an example of an image processing apparatus according to the second embodiment;

FIG. 17 is a flowchart showing an example of an image processing method using the image processing apparatus according to the second embodiment;

FIG. 18 is a flowchart showing an example of an inspection method using the inspection apparatus according to the second embodiment;

FIG. 19 is a block diagram showing an example of an inspection apparatus according to Modified Example 1 of the second embodiment;

FIG. 20 is a configuration diagram showing an example of an inspection apparatus according to Modified Example 2 of the second embodiment;

FIG. 21 is a plan view showing an example of a detector of a monitor unit in the inspection apparatus according to Modified Example 2 of the second embodiment; and

FIG. 22 is a plan view showing an example of a detector of a monitor unit in the inspection apparatus according to Modified Example 2 of the second embodiment.

### DESCRIPTION OF EMBODIMENTS

Embodiments according to the present disclosure will be described hereinafter with reference to the drawings. In the following description, preferred embodiments according to the present disclosure are shown, and the scope of the present disclosure is not limited to the below-shown embodiments. In the following description, components/structures to which the same reference numerals (or symbols) are assigned are substantially the same as each other.

### First Embodiment

An inspection apparatus, an image processing apparatus, an image processing method, and an inspection method according to a first embodiment will be described. Firstly, an inspection apparatus according to this embodiment will be described in the below-shown <Inspection Apparatus> section. Next, an image processing apparatus provided in the inspection apparatus will be described in the below-shown <Image Processing Apparatus> section. Then, an image processing method using the image processing apparatus and an inspection method using the inspection apparatus will be described in the below-shown <Image Processing Method> section and <Inspection Method> section, respectively. Further, their respective modified examples will be described in the below-shown <Modified Example 1> and <Modified Example 2> sections. Note that an image processing apparatus or an image processing method, which are examples of the present disclosure, may be used for an inspection apparatus as described in the below-shown embodiments, but the use of them is not limited to such examples. For example, an image processing apparatus or an image processing method, which are examples of the present disclosure, may be used for an apparatus (review apparatus) that displays an image (photographed image) obtained as a result of illumination of an object on a display or the like.

### Inspection Apparatus

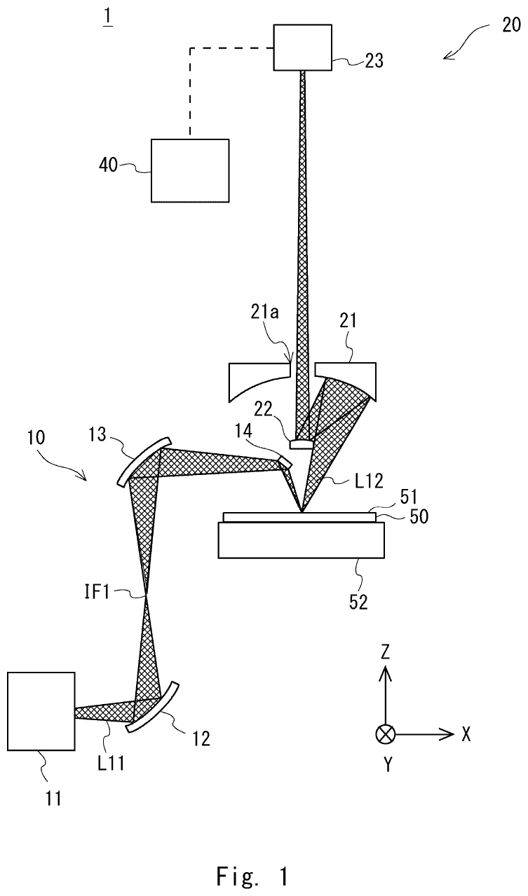

FIG. 1 is a block diagram showing an example of an inspection apparatus 1 according to a first embodiment. The inspection apparatus 1 includes an illumination optical system 10, a photographing optical system 20, and an image processing apparatus 40. The illumination optical system 10 illuminates an object 50 using illumination light L11. The illumination optical system 10 includes, for example, a light source 11, an elliptic mirror 12, an elliptic mirror 13, and a drop-in mirror 14. The photographing optical system 20 takes a photographed image of the object 50 illuminated by the illumination light L11. The photographing optical system 20 includes, for example, a concave mirror 21 with a hole formed therein, a convex mirror 22, and a detector 23. The concave mirror 21 with the hole formed therein and the convex mirror 22 form a Schwarzschild magnification optical system. Note that the illumination optical system 10 and the photographing optical system 20 may further include optical members other than those described above, and do not necessarily have to include all of the above-described optical members.

The image processing apparatus 40 performs image processing on the photographed image of the object 50 taken by the photographing optical system 20. Further, the image processing apparatus 40 inspects the object 50 by using the photographed image which has been subjected to the image processing. The image processing apparatus 40 will be described later.

The inspection apparatus 1 is an apparatus for inspecting the object 50 for defects, contamination, and the like thereon. The object 50 is, for example, an EUV (Extra Ultra Violet) mask sensitive to EUV light. Note that the object 50 is not limited to the EUV mask, and may instead be a photomask sensitive to illumination light L11 having other wavelengths. Further, the object 50 is not limited to the photomask, and may instead be a semiconductor substrate or the like. Note that for the sake of explanation of the inspection apparatus 1, an XYZ-orthogonal coordinate system is introduced. For example, a plane parallel to a stage surface of a stage 52 on which the object 50 is disposed is defined as an XY-plane, and a direction perpendicular to the stage surface is defined as a Z-axis direction. The Z-axis positive direction is also referred to as upward for the sake of convenience.

The light source 11 generates illumination light L11. The illumination light L11 contains, for example, EUV light of 13.5 nm, which is equal to the exposure wavelength of the EUV mask, i.e., the object 50. Note that the illumination light L11 may contain light having other wavelengths. The illumination light L11 generated by the light source 11 is reflected by the elliptic mirror 12. The illumination light L11 reflected by the elliptic mirror 12 travels while being narrowed, and is concentrated at a concentration point IF1. The concentration point IF1 is positioned at a position conjugate with the upper surface 51 of the object 50.

After passing through the concentration point IF1, the illumination light L11 travels while being expanded, and is incident on a reflecting mirror such as the elliptic mirror 13. The illumination light L11 incident on the elliptic mirror 13 is reflected by the elliptic mirror 13, travels while being narrowed, and is incident on the drop-in mirror 14. That is, the elliptic mirror 13 makes the illumination light L11 incident on the drop-in mirror 14 as converging light. The drop-in mirror 14 is disposed above the object 50. The illumination light L11 incident on and reflected by the drop-in mirror 14 is incident on the object 50. That is, the drop-in mirror 14 makes the illumination light L11 incident on the object 50.

The elliptic mirror 13 concentrates the illumination light L11 on the object 50. The illumination optical system 10 is disposed so that when the illumination light L11 illuminates the object 50, an image of the light source 11 is formed on the upper surface 51 of the object 50. Therefore, the illumination optical system 10 provides critical illumination. As described above, the illumination optical system 10 illuminates the object 50 by using the critical illumination by the illumination light L11 generated by the light source 11.

The object 50 is disposed on the stage 52. The illumination light L11 is incident on the object 50 in a direction inclined from the Z-axis direction. That is, the illumination light L11 is obliquely incident on and illuminates the object 50.

The stage 52 is an XYZ-driven stage. It is possible to illuminate a desired area on the object 50 by moving the stage 52 in the X- and Y-axis directions. Further, it is possible to adjust the focus by moving the stage 52 in the Z-axis Further, the stage 52 may be rotated around the X-, Y-, and Z-axes. direction. Note that instead of moving and rotating the stage 52 along the X-, Y-, and Z-axis directions, the illumination optical system 10 and the photographing optical system 20 may be moved and rotated.

The illumination light L11 emitted from the light source 11 illuminates an inspection area on the object 50. Reflected light L12, i.e., light that has been incident on the object 50 in the direction inclined from the Z-axis direction and reflected by the object 50, is incident on the concave mirror 21 with the hole formed therein. A hole 21a is formed at the center of the concave mirror 21.

The reflected light L12 reflected by the concave mirror 21 with the hole formed therein is incident on the convex mirror 22. The convex mirror 22 reflects the reflected light L12 incident from the concave mirror 21 with the hole formed therein toward the hole 21a of the concave mirror 21. The reflected light L12 passing through the hole 21a is detected by the detector 23. The detector 23 may be a detector 23 including a TDI (Time Delay Integration) sensor. The detector 23 acquires image data of the object 50. The detector 23 includes a plurality of photographing elements arranged linearly in one direction. Linear image data taken by the plurality of linearly-arranged photographing elements is referred to as one-dimensional image data or one frame. The detector 23 acquires a plurality of such one-dimensional image data by preforming scanning in a direction perpendicular to the one direction. The photographing elements are, for example, a CCD(s) (Charge Coupled Device(s)). Note that the imaging elements are not limited to the CCD(s).

In this way, the photographing optical system 20 concentrates the reflected light L12 coming from the object 50 illuminated by the illumination light L11, and acquires image data of the object 50 by having the detector 23 detect the concentrated reflected light L12. The image data is, for example, one-dimensional image data.

The reflected light L12 contains information about a defect or the like on the object 50. The normal reflected light of the illumination light L11 that has been incident on the object 50 in the direction inclined from the Z-axis direction is detected by the photographing optical system 20. When there is a defect on the object 50, the defect is observed as a dark image (e.g., a dark spot). Such an observation method is referred to as bright-field observation. The plurality of one-dimensional image data of the object 50 acquired by the detector 23 are output to the image processing apparatus 40 and processed into two-dimensional image data.

The image processing apparatus 40 is connected to the photographing optical system 20 through a signal line or wirelessly. The image processing apparatus 40 receives the image data of the object 50 from the detector 23 in the photographing optical system 20. The image processing apparatus 40 performs image processing on the image data of the object 50 received from the detector 23 as a two-dimensional photographed image. The image processing apparatus 40 inspects the object 50 by using the photographed image 53 which has been subjected to the image processing.

### Image Processing Apparatus

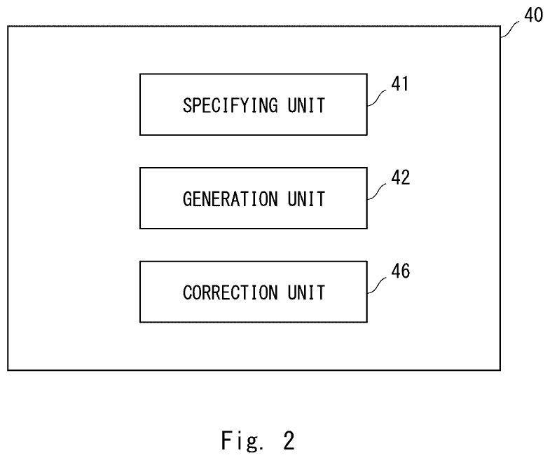

Next, the image processing apparatus 40 will be described. FIG. 2 is a block diagram showing an example of the image processing apparatus 40 according to the first embodiment. As shown in FIG. 2, the image processing apparatus 40 includes a specifying unit 41, a generation unit 42, and a correction unit 46. The specifying unit 41, the generation unit 42, and the correction unit 46 function as specifying means, generation means, and correction means, respectively.

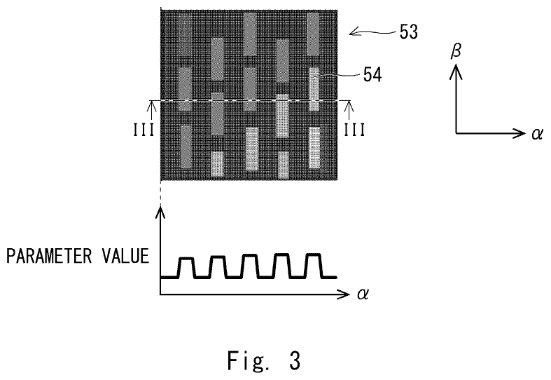

FIG. 3 is a diagram showing an example of a photographed image 53 acquired by the image processing apparatus 40 according to the first embodiment, and parameter values along a line III-III. As shown in FIG. 3, the photographed image 53 is an image obtained by photographing the object 50 in the field of view at a predetermined sampling time. The object 50 may have a repetitive pattern in which a plurality of patterns 54 are arranged. The plurality of patterns 54 may be formed with substantially the same pattern width. Note that for the sake of explanation of the photographed image 53, an αβ-orthogonal coordinate system is introduced. The direction in which the patterns 54 extend in the photographed image 53 is defined as a β-axis direction. The pattern width indicates the length of the minor axis of the pattern 54. Therefore, the pattern width indicates a length in the α-axis direction. In the repetitive pattern, the length between a pattern 54 and another pattern 54 adjacent thereto may be substantially the same (i.e., the substantially constant). Note that in FIG. 3, the reference numerals (or symbols) of some of the patterns 54 are omitted in order to prevent the drawing from becoming complected.

Examples of the object 50 may include a photomask with a pellicle formed thereon. The parameter values of illumination parameters of the illumination light L11 that is emitted when the object 50 is photographed may decrease from one end of the photographed image 53 toward the other end thereof, or may decrease from the center of the photographed image 53 toward the ends of thereof.

The illumination parameter is, for example, the intensity of a signal detected by the detector 23. Such intensity of a signal may reflect the luminance of the object 50 illuminated by the illumination light L11. In such a case, the parameter value is a luminance value. The end of the beam of the illumination light L11 applied to the object 50 may be included in the photographed image 53. That is, in order to prevent the pellicle from being damaged by the illumination light L11, when the beam of the illumination light L11 is narrowed to a size equivalent to the area of the visual field or the like, the end of the beam of the illumination light L11 may be positioned at the edge of the photographed image 53.

As a result, the distribution of luminance becomes such a distribution that the parameter values (e.g., the luminance values) of illumination parameters becomes smaller from the center of the photographed image 53 to the ends thereof. Alternatively, the distribution of luminance may become such a distribution that the parameter values (e.g., the luminance values) of illumination parameters becomes smaller from one end of the photographed image 53 to the other end thereof.

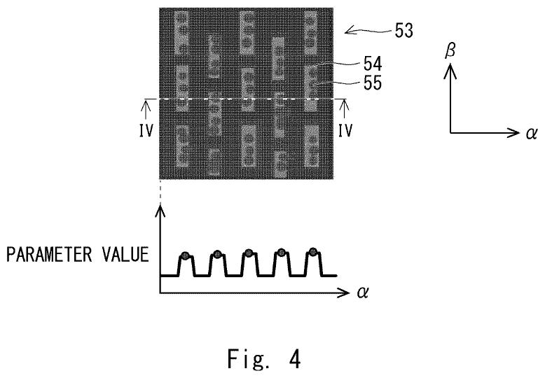

FIG. 4 is a diagram showing an example of the photographed image 53 in which the specifying unit 41 specifies peak points 55, and parameter values along a line IV-IV in the image processing apparatus 40 according to the first embodiment. As shown in FIG. 4, the specifying unit 41 specifies peak points 55 of the illumination parameters in the photographed image 53. Note that in FIG. 4, the reference numerals (or symbols) of some of the peak points 55 are omitted in order to prevent the drawing from becoming complected.

The specifying unit 41 compares the parameter values of the illumination parameters at a plurality of points corresponding to images of the photographed image 53 with each other. For example, the specifying unit 41 may compare the parameter values of the illumination parameters at respective points corresponding to respective pixels of the photographed image 53 with each other. The specifying unit 41 associates the pixels of the photographed image 53 with respective points having coordinates. Specifically, for example, each point has coordinates (α, β). Therefore, the specifying unit 41 associates the pixels of the photographed image 53 with respective points having coordinates on the (α, β)-plane.

The specifying unit 41 specifies a plurality of peak points 55 when the parameter values of the illumination parameters at a plurality of points associated with the pixels of the photographed image 53 are compared with each other. Each of the peak points 55 is a point having a parameter value larger than the parameter values of pixels corresponding to points around this peak point 55. Specifically, the peak point 55 includes a point of which Grad (gradient) of the parameter value is zero with respect to the parameter values of points adjacent thereto. That is, the peak point 55 is a point that is a peak with respect to the surrounding parameter values. As described above, the specifying unit 41 specifies a plurality of peak points 55 that are peaks with respect to surrounding parameter values when the parameter values of the illumination parameters at a plurality of points corresponding to the pixels of the photographed image 53 obtained by photographing the object 50 at a predetermined sampling time are compared with each other.

When the specifying unit 41 specifies peak points 55, it may set a threshold for parameter values of illumination parameters. Then, the specifying unit 41 may specify peak points 55 having peak values larger than the threshold for parameter values. For example, the specifying unit 41 may set the smallest parameter value in the plurality of patterns 54 as the threshold. Therefore, the specifying unit 41 specifies peak points 55 from among the points on the plurality of patterns 54. Further, the specifying unit 41 may set a parameter value of a dark part between patterns 54 adjacent to each other in the photographed image 53 as the threshold. In this case, the specifying unit 41 also specifies peak points 55 from among the points on the plurality of patterns 54.

The specifying unit 41 may set the threshold for parameter values, which is used when specifying peak points 55, based on the pattern width. For example, the specifying unit 41 may set the threshold to a small parameter value when the pattern width is small. When the pattern width is small, the parts in which the illumination light L11 is received and reflected are small. Therefore, the parameter values of the illumination parameters become smaller as a whole. When the pattern width approaches the depth of focus of the elliptic mirror 13, this tendency becomes more outstanding. Therefore, the peak values of peak points 55 also becomes smaller. Therefore, the threshold is set to a small parameter value.

On the other hand, the specifying unit 41 may set the threshold to a large parameter value when the pattern width is large. When the pattern width is large, the parts in which the illumination light L11 is received and reflected are large. Therefore, the parameter values of the illumination parameters become larger as a whole. Therefore, the threshold is set to a large parameter value. In this way, the specifying unit 41 may specify peak points 55 having peak values larger than the threshold for parameter values which is set based on the pattern width.

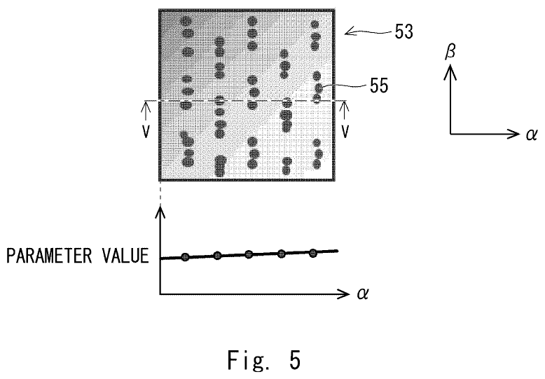

FIG. 5 is a diagram showing an example of a distribution of parameter values generated by the generation unit 42, and parameter values along a line V-V in the generated distribution in the image processing apparatus 40 according to the first embodiment. As shown in FIG. 5, the generation unit 42 generates, based on respective peak values of parameters values at the specified plurality of peak points 55, the distribution of parameter values at respective points. Specifically, the generation unit 42 generates parameter values at a plurality of points between peak points 55 based on the peak values of the peak points 55. For example, the generation unit 42 generates the distribution of parameter values at respective points by interpolating the parameter values at a plurality of points between the peak points 55 based on the peak values. In this way, the generation unit 42 generates the parameter values at a plurality of points between the peak points 55 based on respective peak values of the parameter values at the specified plurality of peak points 55, and thereby generates the distribution of parameter values. Note that the generation unit 42 may generate the distribution of parameter values at respective points corresponding to respective pixels of the photographed image 53, and record, for each of the points corresponding to respective pixels determined based on the distribution, the parameter value at the point. In this way, the parameter values determined based on the distribution of parameter values at respective points are used for a correction process performed by the correction unit 46 (which will be described later).

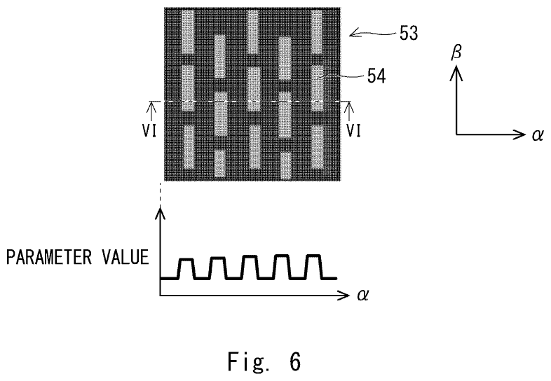

FIG. 6 is a diagram showing an example of a photographed image 53 corrected by the correction unit 46, and parameter values along a line VI-VI in the image processing apparatus 40 according to the first embodiment. As shown in FIG. 6, the correction unit 46 corrects the photographed image 53 by performing image processing on the parameter values of respective pixels of the photographed image 53 at a predetermined sampling time based on the distribution of parameter values generated based on the photographed image 53 at the predetermined sampling time. This image processing may include a smoothing process. That is, the correction unit 46 corrects the photographed image 53 by performing a smoothing process on the parameter values of respective pixels of the photographed image 53 based on the generated distribution of parameter values. Specifically, the correction unit 46 may divide the parameter values of respective pixels of the photographed image 53 by respective parameter values in the generated distribution of parameter values.

Further, the correction unit 46 may also divide the parameter values of respective pixels of the photographed image 53 by the parameter value at respective points that has been determined based on the distribution of parameter values recorded for respective points corresponding to respective pixels by the above-described process performed by the generation unit 42. As described above, the image processing apparatus 40 corrects, by using the correction unit 46, the photographed image 53 at a predetermined sampling time based on the distribution of parameter values that is generated, by the generation unit 42, based on the photographed image 53 obtained at the predetermined sampling time. In this way, the image processing apparatus 40 can cope with variations in the distribution of illumination parameters (such as distribution of luminance) caused by a temporal factor in a highly real-time manner.

Note that although the above description has been given under the assumption that the parameter values of all the pixels in the photographed image 53 are corrected based on the distribution of parameter values, the present disclosure is not limited to such examples, and only some of the pixels in the photographed image 53 may be corrected. Further, although the above description has been given under the assumption that the distribution of parameter values at points corresponding to all the pixels in the photographed image 53 are generated, the present disclosure is not limited to such examples, and the distribution of parameter values may be generated for a plurality of points corresponding to some of the pixels in the photographed image 53.

### Image Processing Method

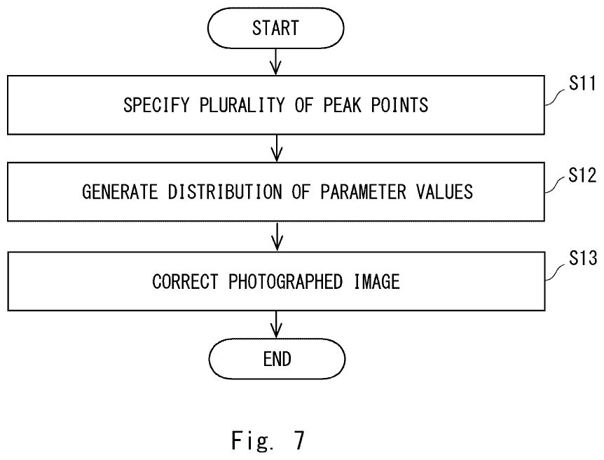

Next, an image processing method using the image processing apparatus 40 will be described. FIG. 7 is a flowchart showing an example of an image processing method using the image processing apparatus 40 according to the first embodiment. As shown in a step S11 in FIG. 7, the specifying unit 41 specifies a plurality of peak points 55. For example, when the parameter values of illumination parameters of respective points corresponding to respective pixels of the photographed image 53, which has obtained by photographing an object 50 at a predetermined sampling time are compared with each other, a plurality of peak points 55 which are peaks with respect to surrounding parameter values are specified. In the step S11, the specifying unit 41 may specify peak points 55 having peak values larger than the threshold for parameter values which is set based on the pattern width.

Next, as shown in a step S12, the generation unit 42 generates a distribution of parameter values. For example, the generation unit 42 generates, based on respective peak values of parameter values at the specified plurality of peak points 55, parameter values at a plurality of points between the peak points 55, and thereby generating the distribution of parameter values at respective points. In the step S12, the generation unit 42 may generate parameter values at a plurality of points between the peak points 55 by interpolating them based on the peak values.

Next, as shown in a step S13, the correction unit 46 corrects the photographed image 53. Specifically, the extraction unit 43 corrects the photographed image 53 by performing image processing on the parameter values of respective pixels of the photographed image 53 at a predetermined sampling time based on the distribution of parameter values generated based on the photographed image 53 at the predetermined sampling time. In the step S13, the image processing may include a smoothing process. In this way, it is possible to perform image processing on the photographed image 53.

### Inspection Method

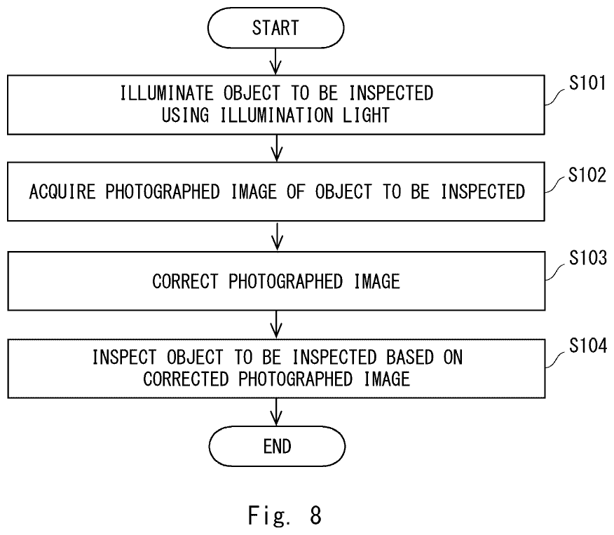

Next, an inspection method will be described as operations performed by the inspection apparatus 1 according to this embodiment. The inspection apparatus 1 corrects the photographed image 53 of the object 50 and inspects the object 50 by using the corrected photographed image 53. FIG. 8 is a flowchart showing an example of an inspection method using the inspection apparatus 1 according to the first embodiment. As shown in a step S101 in FIG. 8, firstly, the object 50 is illuminated by using the illumination light L11. For example, when the object 50 is illuminated by illumination light L11 generated by the light source 11, the illumination optical system 10 is disposed so as to serve as critical illumination. Then, the object 50 is illuminated by the illumination light L11.

Next, as shown in a step S102, the photographed image 53 of the object 50 is acquired. For example, the photographing optical system 20 takes a photographed image 53 of the object 50 illuminated with the illumination light L11. Then, the image processing apparatus 40 acquires the photographed image 53 of the object 50 from the detector 23 of the photographing optical system 20.

Next, as shown in a step S103, the image processing apparatus 40 corrects the photographed image 53. Specifically, the image processing apparatus 40 corrects the photographed image 53 by performing processing based on the generated distribution of parameter values.

Next, as shown in a step S104, the object 50 is inspected by using the corrected photographed image 53 of the object 50. In this way, the inspection apparatus 1 can inspect the object 50.

Next, effects of this embodiment will be described. The image processing apparatus 40 according to this embodiment generates a distribution of parameter values based on peak values at a plurality of peak points 55 specified in the photographed image 53 at a predetermined sampling time. Then, the image processing apparatus 40 corrects the photographed image 53 based on the generated distribution of parameter values. That is, the image processing apparatus 40 can generate the nonuniformity of parameter values such as luminance values at the predetermined sampling time as the distribution of parameter values, and then correct the photographed image 53 at the same sampling time. Therefore, it is possible correct the photographed image 53 at the predetermined sampling time by using the nonuniformity at the predetermined sampling time. In this way, it is possible to eliminate the influence of temporal variations in the photographed image 53, and thereby to improve countermeasures to be taken against changes in the distribution of luminance caused by the time variation factor.

In contrast, in the method in which a photographed image is corrected by using a reference image acquired in advance, such as the one disclosed in Patent Literature 1, since a time t1 at which the reference image is acquired differs from a time t2 at which the photographed image is acquired, it is impossible to reduce temporal variations between the time t1 and the time t2.

In contrast, in this embodiment, since a time t3 at which the distribution of parameter values reflecting the nonuniformity appears and a time t3 at which the photographed image is taken are the same as each other, the nonuniformity can be reduced.

When the generation unit 42 generates the distribution of parameter values, it interpolates parameter values between the peak points 55 based on the peak values. Further, the correction unit 46 performs a smoothing process when it corrects the photographed image 53. By the above-described process, it is possible to reduce the nonuniformity of parameter values in the photographed image 53, and thereby to improve countermeasures to be taken against changes in the distribution of luminance caused by the time variation factor.

Since peak points 55 are specified by using the threshold that is set based on the pattern width, appropriate peak points 55 can be specified when the distribution of parameter values is generated.

### Modified Example 1

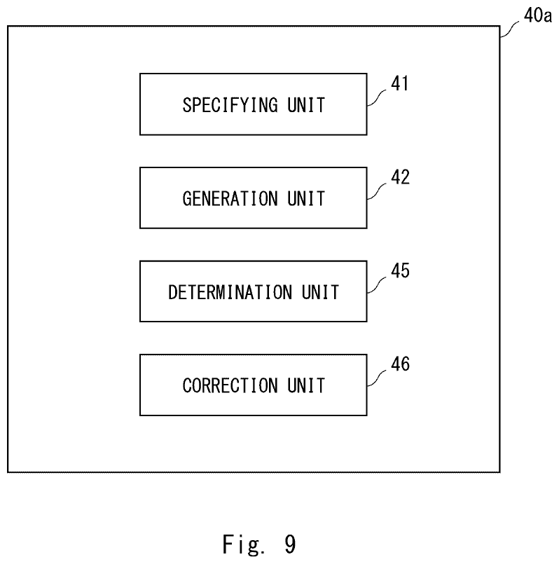

Next, an image processing apparatus according to Modified Example 1 of the first embodiment will be described. In this modified example, the photographed image 53 is corrected after it is determined whether correction conditions are satisfied. FIG. 9 is a block diagram showing an example of an image processing apparatus 40a according to Modified Example 1 of the first embodiment. As shown in FIG. 9, the image processing apparatus 40a further includes a determination unit 45 in addition to the specifying unit 41, the generation unit 42, and the correction unit 46. The determination unit 45 functions as determination means.

The determination unit 45 determines whether correction conditions are satisfied. The correction conditions include, for example, correction conditions for patterns 54 and correction conditions for the distribution of parameter values before and after the sample time. Specifically, the determination unit 45 determines whether the distribution of the positions of the specified plurality of peak points 55 corresponds to the distribution of the patterns 54, or whether the distributions of parameter values of respective patterns 54 are similar to each other. That is, the determination unit 45 determines whether there is a case where a peak point 55 is located outside the patterns 54. In this way, peak points 55 caused by noise or the like are eliminated.

The determination unit 45 may determine whether the distribution of the positions of the specified plurality of peak points 55 corresponds to the distribution of the patterns 54 based on whether the peak points 55 are located on the patterns 54. Further, the determination unit 45 may determine similarity between the distributions of parameter values of respective patterns 54 based on, for example, the number of peak points 55 on each pattern 54, the peak value of each peak point 55, and the arrangement shape of peak points.

When the determination unit 45 determines that the distribution of the positions of the specified plurality of peak points 55 corresponds to the distribution of the patterns 54, the correction unit 46 corrects the photographed image 53. Further, when the determination unit 45 determines that the distributions of parameter values of respective patterns 54 are similar to each other, the correction unit 46 corrects the photographed image 53.

Further, the determination unit 45 also compares a first distribution of parameter values at respective points in the photographed image 53 generated at a sampling time t1 earlier than a predetermined sampling time t2 with a second distribution of parameter values at respective points in the photographed image 53 generated at the predetermined sampling time t2, and thereby determines the degree of difference between the first and second distributions. When the second distribution of parameter values at the time t2 is not different from the first distribution of parameter values at the time t1, the photographed image 53 is corrected by using the first distribution even at the time t2. On the other hand, when the second distribution of parameter values at the time t2 is different from the first distribution of parameter values at the time t1, the photographed image 53 is corrected by newly using the second distribution at the time t2.

For example, the determination unit 45 may determine the degree of difference based on the difference between a parameter value at a predetermined point in the first distribution and a parameter value at the predetermined point in the second distribution. The predetermined point may include a plurality of points. The determination unit 45 may set a threshold for the degree of difference in advance. Then, when the degree of difference is larger than the threshold, the determination unit 45 may determine that the first and second distributions are different from each other. On the other hand, when the degree of difference is equal to or smaller than the threshold, the determination unit 45 may determine that the first and second distributions are not different from each other.

When the determination unit 45 compares the first and second distributions with each other and determines that these distributions are different from each other, the correction unit 46 corrects the photographed image 53 by performing image processing based on the second distribution.

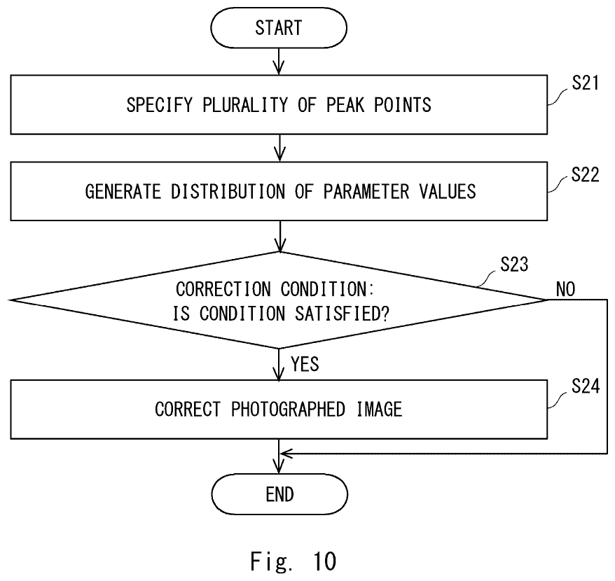

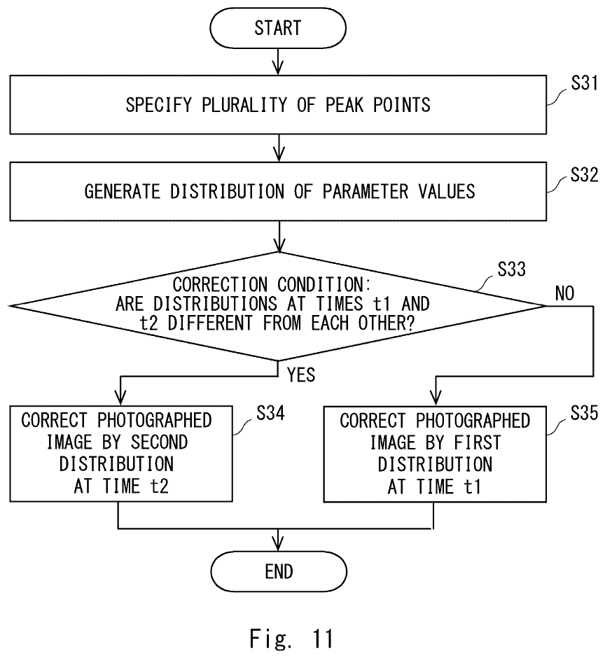

FIG. 10 is a flowchart showing an example of an image processing method using the image processing apparatus 40 according to Modified Example 1 of the first embodiment. FIG. 11 is a flowchart showing an example of an image processing method using the image processing apparatus 40 according to another example of Modified Example 1 of the first embodiment. Steps S21, S22 and S24 in FIG. 10 are similar to the above-described steps S11, S12 and S13, respectively. Steps S31 and S32 in FIG. 11 are similar to the above-described steps S11 and S12, respectively. Note that the steps S21, S22, S23, S31 and S32 may be performed at a sampling time t1 earlier than a predetermined sampling time t2 and at the predetermined sampling time t2.

As shown in the step S23, it is determined whether correction conditions are satisfied in this modified example. For example, the determination unit 45 determines whether the distribution of the positions of the specified plurality of peak points 55 corresponds to the distribution of the patterns 54, or whether the distributions of parameter values of respective patterns 54 are similar to each other. In the step S23, when the determination unit 45 determines that the distribution of the positions of the specified plurality of peak points 55 corresponds to the distribution of the patterns 54, or when the distributions of parameter values of respective patterns 54 are similar to each other, the correction unit 46 corrects the photographed image 53 as shown in the step S24. Then, the series of processes are finished.

On the other hand, in the step S23, when the determination unit 45 determines that the distribution of the positions of the specified plurality of peak points 55 does not correspond to the distribution of the patterns 54, or when the distributions of parameter values of respective patterns 54 are not similar to each other, the series of processes are finished.

Further, in the step S33, a first distribution of parameter values at respective points in the photographed image 53 generated at a sampling time t1 earlier than a predetermined sampling time t2 may be compared with a second distribution of parameter values at respective points in the photographed image 53 generated at the predetermined sampling time t2, and the degree of difference between the first and second distributions may be thereby determined. When it is determined that these distributions are different from each other, as shown in the step S34, the correction unit 46 corrects the photographed image 53 by performing image processing based on the second distribution generated based on the photographed image 53 at the predetermined sampling time t2.

On the other hand, when the determination unit 45 determines that the first and second distributions are not different from each other in the step S33, the correction unit 46 corrects the photographed image 53 by correcting the parameter values based on the first distribution generated based on the photographed image 53 at the sampling time t1.

According to this modified example, the photographed image 53 is corrected according to the determination as to whether correction conditions are satisfied. In this way, it is possible to correct the photographed image 53 according to the predetermined correction condition.

### Modified Example 2

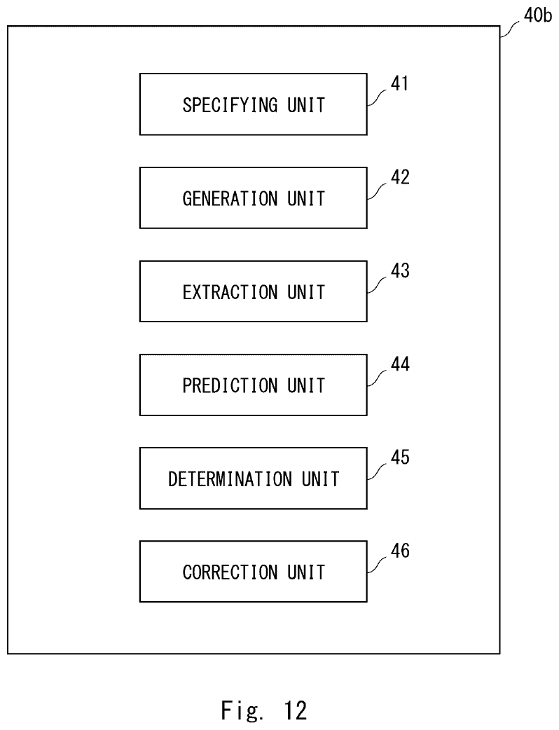

Next, an image processing apparatus according to Modified Example 2 of the first embodiment will be described. FIG. 12 is a block diagram showing an example of an image processing apparatus 40b according to Modified Example 2 of the first embodiment. As shown in FIG. 12, the image processing apparatus 40b further includes an extraction unit 43, a prediction unit 44, and a determination unit 45 in addition to the specifying unit 41, the generation unit 42, and the correction unit 46. The extraction unit 43, the prediction unit 44, and the determination unit 45 function as extraction means, prediction means, and determination means, respectively.

The extraction unit 43 extracts a variation characteristic of a time-dependent temporal variation and a variation characteristic of a position-dependent spatial variation at each point in the above-described degree of difference between the first and second distributions.

The prediction unit 44 predicts the distribution of parameter values at a sampling time t3 later than the predetermined sampling time t2 based on the extracted variation characteristics. The distribution predicted in this process is called a predicted distribution.

The generation unit 42 generates the distribution of parameter values at respective points at the sampling time t3 based on the photographed image 53 obtained at the sampling time t3 by performing the series of processes described above. The distribution generated in this process is called a third distribution.

The determination unit 45 compares the predicted distribution at the sampling time t3 predicted by the prediction unit 44 with the third distribution, which is the distribution of parameter values at the sampling time t3 generated by the generation unit 42, and thereby determines the degree of similarity between these distributions. The determination of the degree of similarity may be similar to the above-described determination of the degree of difference. That is, it may be determined that the distributions are not similar to each other when the degree of difference is larger than a threshold, whereas it may be determined that the distributions are similar to each other when the degree of difference is equal to or smaller than the threshold. The determination unit 45 may compare high-frequency components of the spatial variation characteristic of the predicted distribution with those of the spatial variation characteristic of the third distribution, and thereby determine the degree of similarity between these distributions. When the determination unit 45 has compared the predicted distribution with the third distribution, and these distributions are similar to each other, the correction unit 46 corrects the photographed image 53 by performing image processing based on the third distribution.

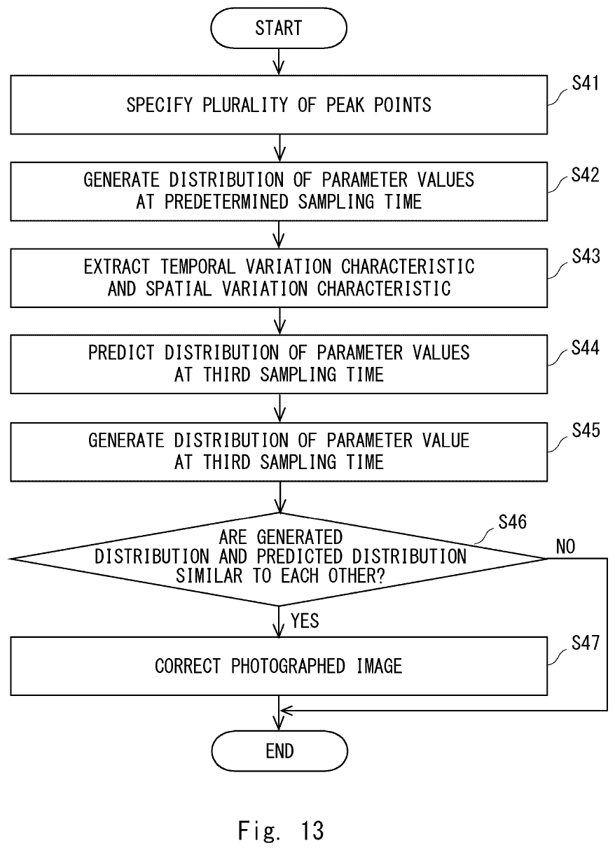

FIG. 13 is a flowchart showing an example of an image processing method using the image processing apparatus 40b according to Modified Example 2 of the first embodiment. Steps S41, S42 and S47 in FIG. 13 are similar to the above-described steps S11, S12 and S13, respectively.

As shown in the step S43, in this modified example, the extraction unit 43 extracts a variation characteristic of a time-dependent temporal variation and a variation characteristic of a position-dependent spatial variation at each point in the degree of difference between the first and second distributions.

Next, as shown in the step S44, the prediction unit 44 predicts the distribution of parameter values at a sampling time t3 later than the predetermined sampling time t2 based on the extracted variation characteristics.

Next, as shown in the step S45, the generation unit 42 generates a third distribution of parameter values at the sampling time t3.

Next, as shown in the step S46, the determination unit 45 compares the generated third distribution with the predicted distribution, and thereby determines the degree of similarity between these distributions. In the step S46, the determination unit 45 may compare high-frequency components of the spatial variation characteristic of the predicted distribution with those of the spatial variation characteristic of the third distribution, and thereby determine the degree of similarity between these distributions. When the determination unit 45 compares the predicted distribution with the third distribution, and determines that these distributions are similar to each other, the correction unit 46 corrects the photographed image by performing image processing based on the third distribution as shown in the step S47.

On the other hand, in the step S46, when the determination unit 45 compares the predicted distribution with the third distribution, and determines that these distributions are not similar to each other, the series of processes are finished.

According to this modified example, it is possible to predict the distribution of parameter values at the sampling time t3. Therefore, it is possible to predict the influence of temporal variations from the sampling time t2 to the sampling time t3, and thereby to reduce the influence of the temporal variations in advance. Further, since the determination unit 45 determines similarity in each of the variation characteristic of temporal variations and that of spatial variations, it can improve the determination as to whether correction conditions are satisfied.

### Second Embodiment

Next, an inspection apparatus, an image processing apparatus, an image processing method, and an inspection method according to a second embodiment will be described in the below-shown <Inspection Apparatus>, <Image Processing Apparatus>, <Image Processing Method>, and <Inspection Method> sections, respectively. Then, their respective modified examples will be described in the below-shown <Modified Example 1> and <Modified Example 2> sections.

### Inspection Apparatus

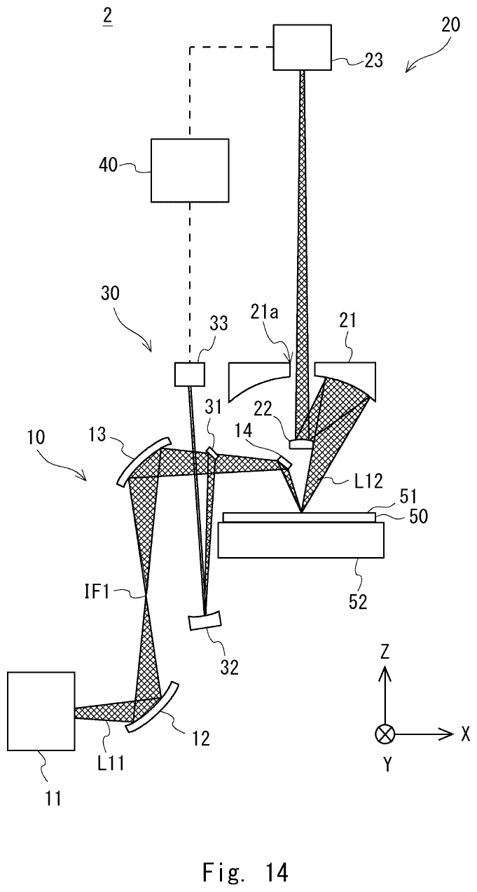

An inspection apparatus according to this embodiment will be described. The inspection apparatus according to this embodiment further includes a monitor unit. FIG. 14 is a configuration diagram showing an example of an inspection apparatus 2 according to the second embodiment. As shown in FIG. 14, the inspection apparatus 2 further includes a monitor unit 30. The monitor unit 30 includes a cut mirror 31, a concave mirror 32, and a detector 33.

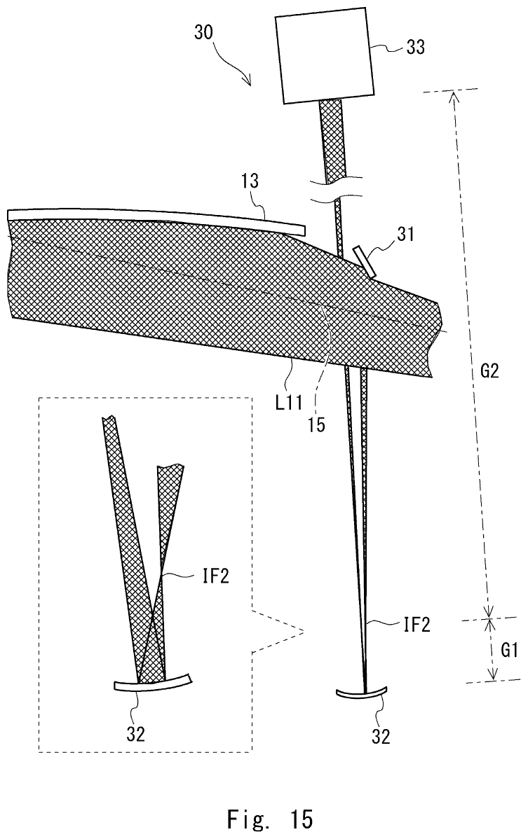

FIG. 15 is a configuration diagram showing an example of the monitor unit 30 in the inspection apparatus 2 according to the second embodiment. FIG. 15 also shows an enlarged diagram of a part of the monitor unit 30 near the concave mirror 32. As shown in FIGS. 14 and 15, the cut mirror 31 of the monitor unit 30 is disposed between the elliptic mirror 13 and the drop-in mirror 14, and extracts a part of the illumination light L11 between the elliptic mirror 13 and the drop-in mirror 14. The cut mirror 31 reflects a small part of the beam of the illumination light L11 so as to cut out it from the beam. The part of the beam is, for example, an upper part of the beam.

In the cross-sectional area of the illumination light L11 perpendicular to the optical axis 15 thereof at the position where the cut mirror 31 is disposed, the cross-sectional area of the part of the illumination light L11 reflected by the cut mirror 31 is smaller than the cross-sectional area of the remaining part of the illumination light L11.

For example, when the cross-sectional area of the illumination light L11 perpendicular to the optical axis 15 at the position where the cut mirror 31 is disposed is defined as 100, the cross-sectional area of the above-described part thereof is about 1. In the illumination light L11 extracted from the light source 11, the extraction angle measured from the direction perpendicular to the optical axis 15 is, for example, ±7°. The angle of the illumination light L11 used for an EUV mask is, for example, in the range of ±6°. In order to use the part of the illumination light L11 for the monitor unit 30, an upper part of the beam of the illumination light L11 is slightly extracted, for example, in the range of 1° by the cut mirror 31. Even when the upper part of the beam is slightly extracted as described above, the amount of the illumination light L11 incident on the EUV mask does not decrease very much. Therefore, it is possible to prevent or reduce the deterioration in the accuracy of the inspection of the object 50.

The cut mirror 31 is disposed, for example, at a position close to the pupil in the illumination optical system 10. By extracting the illumination light L11 by the cut mirror 31 at the position close to the pupil in the illumination optical system 10, it is possible to obtain a satisfactory correlation between image data acquired by the detector 23 and image data acquired by the detector 33. Even when the numerical aperture (NA) for the detector 23 is different from the NA for the detector 33, and hence their point spread functions (PSFs) are different from each other, the difference in the NA does not affect the inspection in this embodiment because the plasma size is sufficiently larger than the PSF size.

The illumination light L11 reflected by the cut mirror 31 travels while being narrowed, and is concentrated at a concentration point IF2. After that, the illumination light L11 is incident on the concave mirror 32 while being expanded.

The concave mirror 32 and a plurality of mirrors (not shown) expands the illumination light L11 extracted by the cut mirror 31. A distance between the concentration point IF2 and the concave mirror 32 is referred to as a distance G1, and a distance between the concentration point IF2 and the detector 33 is referred to as a distance G2. The image data acquired by the detector 33 can be magnified by a high magnification factor. However, in order to obtain a high magnification (up to 500), the distance G2 is greatly increased. For example, when the distance G1 is set to up to 5 mm, the distance G2 is set to up to 2,500 mm, so that the magnification is set to 500 times. For example, the magnification can be set to 500 times by using a plurality of mirrors.

In this embodiment, the magnification of the image data of the distribution of illumination parameters (e.g., distribution of luminance) acquired by the monitor unit 30 is set to the same magnification as that of the image data of the object 50 acquired by the photographing optical system 20. Note that the magnification of the image data of the distribution of illumination parameters acquired by the monitor unit 30 may be set to a value lower than that of the image data of the object 50 acquired by the photographing optical system 20. The solid angle required for the extraction is the square of the magnification ratio. For example, when the magnification of the detector 23 is set to 20 times and the magnification of the detector 33 is set to 2 times, the solid angle required for the extraction by the cut mirror 31 is 1/100 of the solid angle for the extraction from the light source 11. When it is converted in terms of NA, it is 1/10.

The illumination light L11 which has been incident on the concave mirror 32 and reflected by the concave mirror 32 is detected by the detector 33. The detector 33 includes, for example, a TDI sensor. The detector 33 acquires a monitor image of the distribution of luminance or the like of the illumination light L11. The detector 33 includes a plurality of photographing elements linearly arranged in one direction. Similarly to the detector 23, the linear image data taken by the plurality of linearly-arranged photographing elements is referred to as one-dimensional image data or one frame. The detector 33 acquires a plurality of such one-dimensional image data by performing scanning in a direction perpendicular to the one direction. The one-dimensional image data acquired by the detector 33 shows the power fluctuation (power variations) and the distribution of luminance of the illumination light L11. The photographing elements are, for example, a CCD(s) (Charge Coupled Device(s)). Note that the imaging elements are not limited to the CCD(s).

For example, an optical system is disposed so that an image of the light source 11 of the illumination light L11 is formed on the detector 33. In this way, the monitor unit 30 acquires image data of the distribution of luminance of the illumination light L11, which is detected by illuminating the detector 33 with critical illumination by using a part of the illumination light L11. Therefore, it is possible to accurately correct the distribution of luminance and the power fluctuation.

As described above, the monitor unit 30 concentrates a part of the illumination light L11, detects the concentrated illumination light L11 by the detector 33, and acquires image data including the distribution of illumination parameters, such as power fluctuation and the distribution of luminance of the illumination light L11. The image data acquired by the detector 33 is output to an image processing apparatus 40c and processed into two-dimensional image data.

The image processing apparatus 40c is connected to the monitor unit 30 through a signal line or wirelessly. The image processing apparatus 40c receives image data including the distribution of illumination parameters from the detector 33 in the monitor unit 30. The image processing apparatus 40c performs image processing on the image data of the object 50 received from the detector 33 as the two-dimensional monitor image.

### Image Processing Apparatus

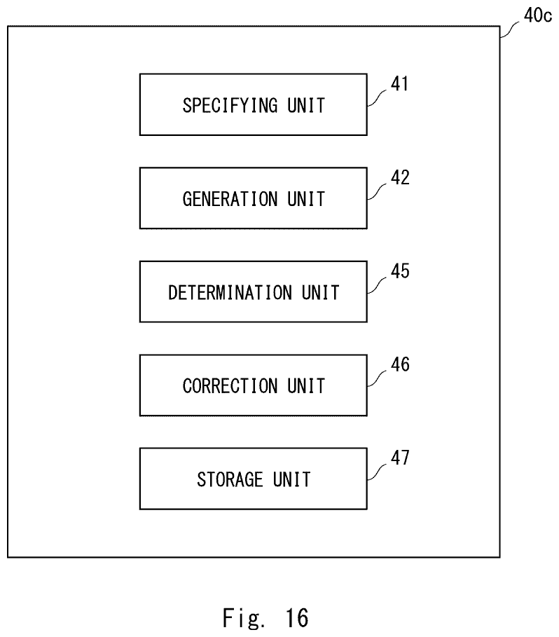

Next, an image processing apparatus according to the second embodiment will be described. FIG. 16 is a block diagram showing an example of an image processing apparatus 40c according to the second embodiment. As shown in FIG. 16, the image processing apparatus 40c includes a specifying unit 41, a generation unit 42, a determination unit 45, a correction unit 46, and a storage unit 47. The storage unit 47 functions as storage means.

In this embodiment, the specifying unit 41 specifies a plurality of peak points 55 that are peaks with respect to surrounding parameter values when parameter values of illumination parameters of respective points corresponding to respective pixels of the photographed image 53 obtained by photographing the object 50 by using a part of the illumination light L11 at a predetermined sampling time t2 are compared with each other. Note that the part of the illumination light L11 is a part thereof that is not extracted by the cut mirror 31.

The generation unit 42 generates, based on respective peak values of parameter values at the specified plurality of peak points 55, parameter values at a plurality of points between the peak points 55, and thereby generate a distribution of parameter values (hereinafter referred to as a fourth distribution) at respective points. At the same time, the generation unit 42 generates a distribution of parameter values (hereinafter referred to as a fifth distribution) at respective points corresponding to respective pixels of a monitor image photographed by receiving another part of the illumination light L11. Note that the other part of the illumination light L11 is a part that is extracted by the cut mirror 31.

The determination unit 45 compares the fourth distribution of parameter values at respective points in the photographed image 53 with the fifth distribution of parameter values at respective points in the monitor image. Then, the determination unit 45 determines the degree of similarity between these distributions. When the determination unit 45 determines that these distributions are similar to each other, the correction unit 46 corrects the photographed image 53. Specifically, the correction unit 46 corrects the photographed image 53 by performing image processing on the parameter values of respective pixels of the photographed image 53 at the predetermined sampling time t2 based on the generated fourth distribution of parameter values.

The fact that the fourth and fifth distributions are similar to each other as described above means that the fourth distribution generated by the generation unit 42 is similar to the fifth distribution of the illumination light L11 acquired by the monitor unit 30. That is, this indicates that the fourth distribution agrees with the result of the monitoring by the monitor unit 30. This indicates that it is reasonable to perform image processing on the photographed image 53 based on the fourth distribution.

When the determination unit 45 determines that the fourth and fifth distributions are not similar to each other, it is determined that there is an abnormality, e.g., there is an abnormality in the inspection apparatus 2. Further, the determination unit 45 may extract a difference between the fourth distribution of parameter values at respective points in the photographed image 53 and the fifth distribution of parameter values at respective points in the monitor image. The correction unit 46 may correct the fifth distribution based on the extracted difference. This means that the reliability of the fourth distribution generated from the photographed image 53 is higher than that of the fifth distribution acquired by the monitor unit 30 in the inspection apparatus 2. Note that when the reliability of the fifth distribution is high, the correction unit 46 may correct the fourth distribution based on the extracted difference.

The storage unit 47 stores state parameters of the inspection apparatus 2 at the sampling time at which a predetermined difference is extracted in association with the difference between the fourth and fifth distributions extracted by the determination unit 45. The state parameters of the inspection apparatus 2 include, for example, a temperature(s) of a predetermined component(s) of the inspection apparatus 2 and a temperature inside the housing. Note that the state parameters of the inspection apparatus 2 may include not only the temperatures but also the humidity of the inspection apparatus 2, the output of the light source 11, the output of the illumination light L11, and the like. When the determination unit 45 may determine that the same state parameters are acquired later than the sampling time, the correction unit 46 may correct at least one of the fourth and fifth distributions based on the difference of the distribution that is recorded in association with these state parameters.

### Image Processing Method

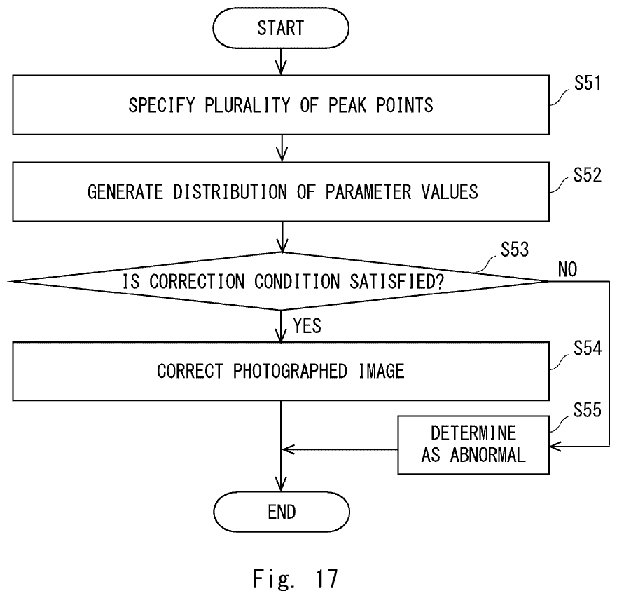

Next, an image processing method using the image processing apparatus 40c according to this embodiment will be described. FIG. 17 is a flowchart showing an example of an image processing method using the image processing apparatus 40c according to the second embodiment. As shown in a step S51 in FIG. 17, the specifying unit 41 specifies a plurality of peak points 55 that are peaks with respect to surrounding parameter values when parameter values of illumination parameters of respective points corresponding to respective pixels of the photographed image 53 obtained by photographing the object 50 by using a part of the illumination light L11 at a predetermined sampling time t2 are compared with each other.

Next, as shown in a step S52, the generation unit 42 generates, based on respective peak values of parameter values at the specified plurality of peak points 55, parameter values at a plurality of points between the peak points 55, and thereby generate a fourth distribution of parameter values at respective points. At the same time, the generation unit 42 generates a fifth distribution of parameter values at respective points corresponding to respective pixels of the monitor image that the monitor unit 30 has taken by receiving another part of the illumination light L11 based on, for example, luminance at the respective points.

Next, as shown in a step S53, it is determined whether correction conditions are satisfied. Specifically, the determination unit 45 compares the fourth distribution of parameter values at respective points in the photographed image 53 with the fifth distribution of parameter values at respective points in the monitor image. Then, the determination unit 45 determines the degree of similarity between these distributions. When the determination unit 45 determines that these distributions are similar to each other, the correction unit 46 corrects the photographed image 53 as shown in a step S54. Specifically, the correction unit 46 corrects the photographed image 53 by performing image processing on the parameter values of respective pixels of the photographed image 53 at a predetermined sampling time based on the fourth distribution. After that, the series of processes are finished.

On the other hand, in the step S53, when the determination unit 45 determines that the fourth and fifth distributions are not similar to each other, the determination unit 45 may determine that there is an abnormality, for example, there is an abnormality in the inspection apparatus 2 as shown in a step S55. After that, the series of processes are finished.

Note that in the step S53, the determination unit 45 may extract a difference between the fourth distribution of parameter values at respective points in the photographed image 53 and the fifth distribution of parameter values at respective points in the monitor image. In this case, in the step S54, the correction unit 46 may correct the fifth distribution based on the extracted difference.

Further, in the step S53, the determination unit 45 may determine whether the same state parameters as those stored in the storage unit 47 have been acquired later than the sampling time. When the determination unit 45 determines that the same state parameters are acquired later than the sampling time, the correction unit 46 may correct at least one of the fourth and fifth distributions based on the difference of the distribution that is recorded in association with these state parameters.

### Inspection Method

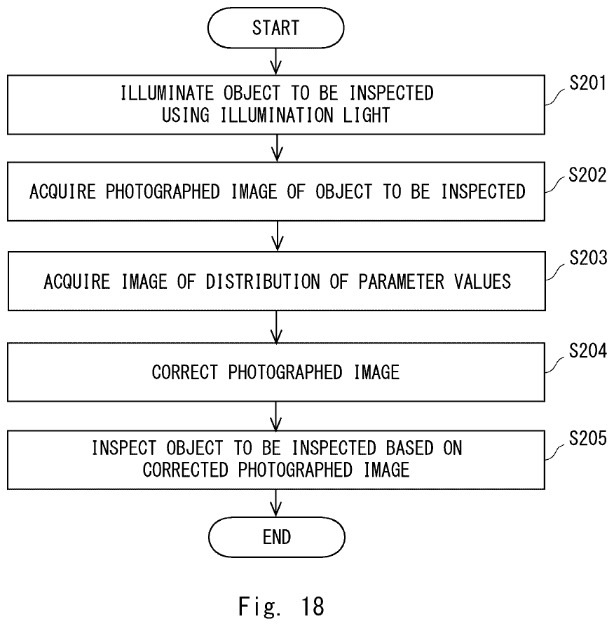

Next, an inspection method using the inspection apparatus 2 according to this embodiment will be described. FIG. 18 is a flowchart showing an example of an inspection method using the inspection apparatus 2 according to the second embodiment. Steps S201, S202 and S205 in FIG. 18 are similar to the steps S101, S102 and S104 in the inspection method using the inspection apparatus 1 described above.

As shown in a step S203, a distribution of parameter values in a monitor image photographed by receiving another part of the illumination light L11 is acquired from the monitor image.

Next, as shown in a step S204, image processing is performed on the photographed image 53. Specifically, image processing is performed on the photographed image 53 by the image processing method using the image processing apparatus 40c described above. In this way, the object 50 can be inspected.

According to this embodiment, it is possible to check the reliability of the fourth distribution of parameter values by using the monitor unit 30. Further, it is possible to check the reliability of the monitor unit 30 by determining the degree of similarity between the fourth and fifth distributions. As described above, in this embodiment, the function of detecting the nonuniformity of the illumination light L11 and that of the monitor unit 30 can be complemented with each other.

### Modified Example 1

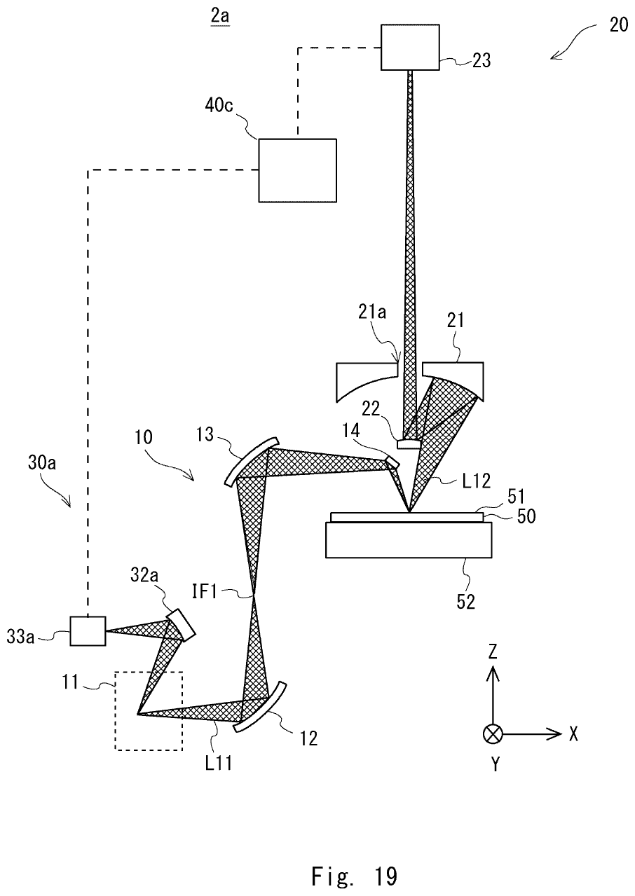

Next, an inspection apparatus according to Modified Example 1 of the second embodiment will be described. This Modified Example includes a modified example of the monitor unit 30. FIG. 19 is a block diagram showing an example of an inspection apparatus 2a according to Modified Example 1 of the second embodiment. As shown in FIG. 19, in the inspection apparatus 2a, the monitor unit 30a includes a concave mirror 32a and a detector 33a. In this modified example, another part of the illumination light L11 is directly separated from the light source 11 instead of being extracted by the cut mirror 31. Specifically, the light source 11 emits illumination light L11 to the elliptic mirror 12 and also to the concave mirror 32a. The concave mirror 32a reflects the illumination light L11 to the detector 33a. The detector 33a acquires image data of parameter values of the distribution of luminance or the like of the illumination light L11. The detector 33a outputs the image data to the image processing apparatus 40c. In this way, the image processing apparatus 40c can acquire a photographed image 53 and a monitor image.

### Modified Example 2

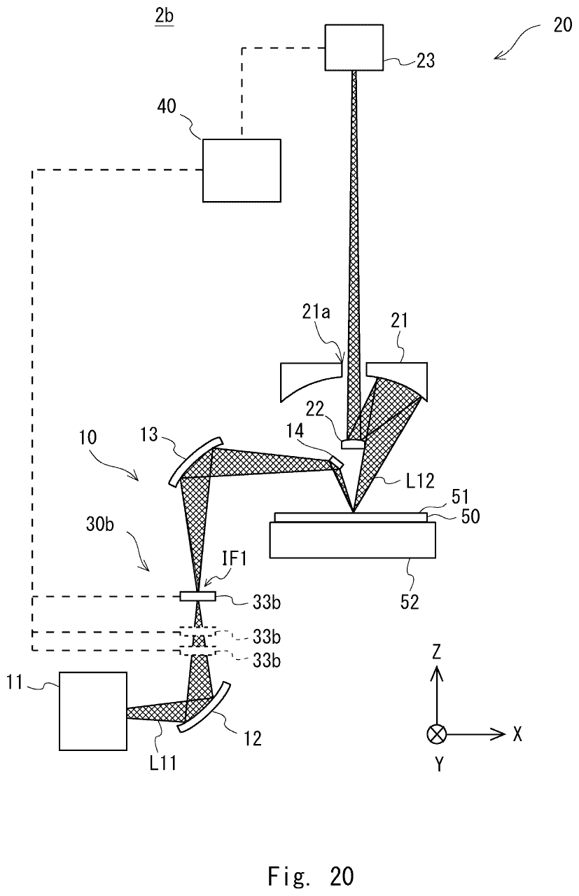

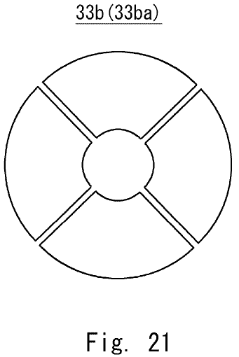

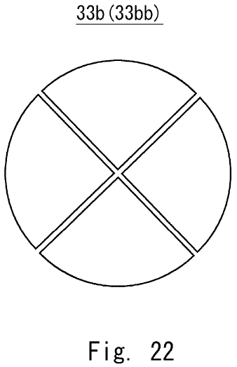

Next, an inspection apparatus according to Modified Example 2 of the second embodiment will be described. FIG. 20 is a block diagram showing an example of an inspection apparatus 2b according to Modified Example 2 of the second embodiment. FIGS. 21 and 22 are plan views showing examples of a detector 33b of a monitor unit 30b in the inspection apparatus 2b according to Modified Example 2 of the second embodiment.

As shown in FIG. 20, in the inspection apparatus 2b, the detector 33b of the monitor unit 30b may be disposed on the optical path of the illumination light L11. The detector 33b may be disposed at a concentration point IF1 on the optical path of the illumination light L11. The detector 33b may be disposed at a position away from the concentration point IF1. As shown in FIGS. 21 and 22, the detector 33b may be a multi-cell detector 33b including a plurality of detection units. The detector 33b may be a hollow multi-cell detector 33ba as shown in FIG. 21, or may be a transmission-type multi-cell detector 33bb as shown in FIG. 22. The hollow multi-cell detector 33ba may be disposed at the concentration point IF1 on the optical path of the illumination light L11, and the transmission-type multi-cell detector 33bb may be disposed at a position away from the concentration point IF1. In this way, the image processing apparatus 40c can acquire a monitor image.

While embodiments according to the present disclosure have been described above, the present disclosure includes modifications as appropriate without impairing the objects and advantages thereof, and is not limited by the above-described embodiments. Further, combinations of the configurations of any two or more of the first and second embodiments and their modified examples are also within the scope of the technical concept of the present disclosure. Further, the below-described configurations are also within the scope of the technical concept of the embodiments.

### Supplementary Note 1

An image processing method comprising:
specifying, when parameter values of illumination parameters at a plurality of points corresponding to pixels of a photographed image obtained by photographing an object at a predetermined sampling time are compared with each other, a plurality of peak points each of which is a peak with respect to surrounding parameter values;
generating, based on respective peak values of the parameter values at the specified plurality of peak points, the parameter values at a plurality of points between the peak points, and thereby generating a distribution of the parameter values; and
correcting the photographed image obtained at the predetermined sampling time by correcting the parameter values of at least one pixel of the photographed image based on the generated distribution of the parameter values.

### Supplementary Note 2

The image processing method described in Supplementary note 1, wherein in the generating of the distribution of parameter values, the parameter values at the plurality of points between the peak points are generated by interpolating the parameter values based on the peak values.

### Supplementary Note 3

The image processing method described in Supplementary note 1, wherein in the correcting of the photographed image, the parameter values are corrected by a smoothing process.

### Supplementary Note 4

The image processing method described in Supplementary note 1, wherein
the object has a repetitive pattern in which a plurality of patterns formed with substantially the same pattern width are arranged, and
in the specifying of the plurality of peak points, the peak points having the peak values larger than a threshold for the parameter values are specified, the threshold being set based on the pattern width.

### Supplementary Note 5

The image processing method described in Supplementary note 1, wherein
the object has a repetitive pattern in which a plurality of patterns formed with substantially the same pattern width are arranged, and
the image processing method further comprises determining whether a distribution of positions of the specified plurality of peak points corresponds to a distribution of the patterns, or whether distributions of the parameter values of respective patterns are similar to each other, and
in the determining, when it is determined that distributions correspond to each other or are similar to each other, the photographed image is corrected.

### Supplementary Note 6

The image processing method described in Supplementary note 1, further comprising comparing a first distribution of the parameter values generated based on a photographed image of the object at a sampling time earlier than the predetermined sampling time with a second distribution of the parameter values generated based on a photographed image of the object at the predetermined sampling time, and thereby determining a degree of difference between the first and second distributions, wherein
when it is determined that the distributions are different from each other in the determining, the photographed image of the object obtained at the predetermined sampling time is corrected by correcting a parameter value of at least one pixel of the photographed image based on the second distribution.

### Supplementary Note 7

The image processing method described in Supplementary note 6, further comprising:
extracting a variation characteristic of a time-dependent temporal variation and a variation characteristic of a position-dependent spatial variation in the distribution of parameter values based on the first and second distributions;
predicting a predicted distribution of the parameter values at a third sampling time later than the predetermined sampling time based on the extracted variation characteristics;
generating a third distribution of the parameter values based on the photographed image of the object obtained at the third sampling time; and
comparing the predicted distribution with the third distribution, and thereby determining a degree of similarity between the predicted distribution and the third distribution, wherein
when it is determined that the predicted distribution and the third distribution are similar to each other in the determining of the degree of similarity, the photographed image is corrected based on the second distribution.

### Supplementary Note 8

The image processing method described in Supplementary note 7, wherein, in the determining of the degree of similarity, a degree of similarity between the predicted distribution and the third distribution is determined by comparing a high-frequency component in the variation characteristic of the spatial variation of the predicted distribution with a high-frequency component in the variation characteristic of the spatial variation of the third distribution.

### Supplementary Note 9

The image processing method described in Supplementary note 1, wherein
the parameter value of illumination light that is applied to the object when the object is photographed becomes smaller from a center of the photographed image toward to an end thereof, and
an end of a beam of the illumination light that is applied to the object is included in the photographed image.

### Supplementary Note 10

The image processing method described in Supplementary note 9, wherein the object is a photomask in which a pellicle is formed, and the illumination light includes EUV.

### Supplementary Note 11

An image processing method comprising:
specifying, when parameter values of illumination parameters at a plurality of points corresponding to pixels of a photographed image obtained by photographing an object at a predetermined sampling time by using a part of illumination light are compared with each other, a plurality of peak points each of which is a peak with respect to surrounding parameter values;
generating, based on respective peak values of the parameter values at the specified plurality of peak points, the parameter values at a plurality of points between the peak points, and thereby generating a fourth distribution of the parameter values and generate a fifth distribution of the parameter values at a plurality of points corresponding to pixels of a monitor image photographed by receiving another part of the illumination light;
determining a degree of similarity between the fourth and fifth distributions by comparing the fourth and fifth distributions; and
correcting the parameter values of at least one pixel in the photographed image obtained at the predetermined sampling time based on the generated fourth distribution of parameter values, wherein
when it is determined that the fourth and fifth distributions are similar to each other in the determining of the degree of similarity, the photographed image is corrected.

### Supplementary Note 12

The image processing method described in Supplementary note 11, further comprising determining, when it is determined that the distributions are not similar to each other in the determining of the degree of similarity between the distributions, that there is an abnormality.

### Supplementary Note 13

The image processing method described in Supplementary note 11, wherein
in the determining of the degree of similarity between the distributions, a difference between the fourth and the fifth distributions is extracted, and
in the correcting of the photographed image, the fifth distribution is corrected based on the difference.

### Supplementary Note 14

The image processing method described in Supplementary note 13, wherein in the determining of the degree of similarity between the distributions, when it is determined that a state parameter that is stored together with the difference in a storage unit in which the difference is stored and is the same as the state parameter of the inspection apparatus in which the object is photographed at the sampling time at which the difference is extracted is acquired later than the sampling time, the fifth distribution is corrected based on the difference.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An image processing apparatus comprising:
a specifying unit configured to specify, when parameter values of illumination parameters at a plurality of points corresponding to pixels of a photographed image obtained by photographing an object at a predetermined sampling time are compared with each other, a plurality of peak points each of which is a peak with respect to surrounding parameter values;
a generation unit configured to generate, based on respective peak values of the parameter values at the specified plurality of peak points, the parameter values at a plurality of points between the peak points, and thereby generate a distribution of the parameter values; and
a correction unit configured to correct the photographed image obtained at the predetermined sampling time by correcting the parameter values of at least one pixel of the photographed image based on the generated distribution of the parameter values.

2. The image processing apparatus according to claim 1, wherein the generation unit generates the parameter values at the plurality of points between the peak points by interpolating the parameter values based on the peak values.

3. The image processing apparatus according to claim 1, wherein the correction unit corrects the parameter values by a smoothing process.

4. The image processing apparatus according to claim 1, wherein
the object has a repetitive pattern in which a plurality of patterns formed with substantially the same pattern width are arranged, and
the specifying unit specifies the peak points having the peak values larger than a threshold for the parameter values, the threshold being set based on the pattern width.

5. The image processing apparatus according to claim 1, wherein
the object has a repetitive pattern in which a plurality of patterns formed with substantially the same pattern width are arranged,
the image processing apparatus further comprises a determining unit configured to determine whether a distribution of positions of the specified plurality of peak points corresponds to a distribution of the patterns, or whether distributions of the parameter values of respective patterns are similar to each other, and
when the determination unit determines that distributions correspond to each other or are similar to each other, the correction unit corrects the photographed image.

6. The image processing apparatus according to claim 1, further comprising a determination unit configured to compare a first distribution of the parameter values generated based on a photographed image of the object at a sampling time earlier than the predetermined sampling time with a second distribution of the parameter values generated based on a photographed image of the object at the predetermined sampling time, and thereby determine a degree of difference between the first and second distributions, wherein
when the determination unit determines the first and second distributions are different from each other, the correction unit corrects the photographed image of the object obtained at the predetermined sampling time by correcting a parameter value of at least one pixel of the photographed image based on the second distribution.

7. The image processing apparatus according to claim 6, further comprising:
an extraction unit configured to extract a variation characteristic of a time-dependent temporal variation and a variation characteristic of a position-dependent spatial variation in the distribution of parameter values based on the first and second distributions; and
a prediction unit configured to predict a predicted distribution of the parameter values at a third sampling time later than the predetermined sampling time based on the extracted variation characteristics,
the generation unit generates a third distribution of the parameter values based on the photographed image of the object obtained at the third sampling time,
the determination unit compares the predicted distribution with the third distribution, and thereby determine a degree of similarity between the predicted distribution and the third distribution, and
when the determination unit determines that the predicted distribution and the third distribution are similar to each other, the correction unit corrects the photographed image based on the third distribution.

8. The image processing apparatus according to claim 7, wherein the determination unit determines a degree of similarity between the predicted distribution and the third distribution by comparing a high-frequency component in the variation characteristic of the spatial variation of the predicted distribution with a high-frequency component in the variation characteristic of the spatial variation of the third distribution.

9. The image processing apparatus according to claim 1, wherein
In the above-described image processing apparatus, the parameter value of illumination light that is applied to the object when the object is photographed becomes smaller from a center of the photographed image toward to an end thereof, and
an end of a beam of the illumination light that is applied to the object is included in the photographed image.

10. The image processing apparatus according to claim 9, wherein the object is a photomask in which a pellicle is formed, and the illumination light includes EUV.

11. An image processing apparatus comprising:
a specifying unit configured to specify, when parameter values of illumination parameters at a plurality of points corresponding to pixels of a photographed image obtained by photographing an object at a predetermined sampling time by using a part of illumination light are compared with each other, a plurality of peak points each of which is a peak with respect to surrounding parameter values;
a generation unit configured to generate, based on respective peak values of the parameter values at the specified plurality of peak points, the parameter values at a plurality of points between the peak points, and thereby generate a fourth distribution of the parameter values and generate a fifth distribution of the parameter values at a plurality of points corresponding to pixels of a monitor image photographed by receiving another part of the illumination light;
a determination unit configured to determine a degree of similarity between the fourth and fifth distributions by comparing the fourth and fifth distributions; and
a correction unit configured to correct the photographed image obtained at the predetermined sampling time by correcting the parameter values of at least one pixel of the photographed image based on the generated fourth distribution, wherein
when the determination unit determines that the fourth and fifth distributions are similar to each other, the correction unit corrects the photographed image.

12. The image processing apparatus according to claim 11, wherein when the determination unit determines that the fourth and fifth distributions are not similar to each other, the determination unit determines that there is an abnormality.

13. The image processing apparatus according to claim 11, wherein
In the above-described image processing apparatus, the determination unit extracts a difference between the fourth and the fifth distributions, and
the correction unit corrects the fifth distribution based on the difference.

14. The image processing apparatus according to claim 13, further comprising a storage unit configured to store a state parameter of an apparatus in which the object is photographed at the sampling time at which a predetermined difference is extracted, together with the predetermined difference, wherein
when the determination unit determines that the same state parameter is acquired later than the sampling time, the correction unit corrects the fifth distribution based on the predetermined difference.

15. An inspection apparatus comprising:
an illumination optical system configured to illuminate an object using illumination light;
a photographing optical system configured to take a photographed image of the object illuminated by the illumination light; and
an image processing apparatus according to claim 1, wherein
the image processing apparatus inspects the object by using the photographed image that has been subjected to image processing.

16. An image processing method comprising:
specifying, when parameter values of illumination parameters at a plurality of points corresponding to pixels of a photographed image obtained by photographing an object at a predetermined sampling time are compared with each other, a plurality of peak points each of which is a peak with respect to surrounding parameter values;
generating, based on respective peak values of the parameter values at the specified plurality of peak points, the parameter values at a plurality of points between the peak points, and thereby generating a distribution of the parameter values; and
correcting the photographed image obtained at the predetermined sampling time by correcting the parameter values of at least one pixel of the photographed image based on the generated distribution of the parameter values.

17. An inspection method comprising:
illuminating an object using illumination light;
taking a photographed image of the object illuminated by the illumination light;
correcting the photographed image by the image processing method according to claim 16; and
inspecting the object by using the photographed image that has been subjected to image processing.
